(19) United States
(12) Patent Application Publication
(10) Pub. No.: US 2017/0057067 A1
(43) Pub. Date: Mar. 2, 2017

(54) NAIL GUN ASSEMBLY INCLUDING GUIDE

(71) Applicants: PECO PALLET, INC., Irvington, NY (US); VIPER INDUSTRIAL PRODUCTS, INC., Greenbrier, AR (US)

(72) Inventors: Kyoungsu Stephen Yoo, Kildeer, IL (US); Del Allen Wagner, Thomasboro, IL (US)

(21) Appl. No.: 15/248,467

(22) Filed: Aug. 26, 2016

Related U.S. Application Data
(60) Provisional application No. 62/212,724, filed on Sep. 1, 2015.

(51) Int. Cl. B25C 1/00

(52) U.S. Cl. CPC B25C 1/008

(57) ABSTRACT

Various embodiments of a nail gun assembly and a method of using same are disclosed. The nail gun assembly includes a nail gun including a housing and a nailing mechanism disposed at least partially within the housing. The assembly also includes a guide connected to the housing that includes a contact surface that forms a guide plane that is substantially orthogonal to a tool axis of the nail gun, where the contact surface is adapted to contact a working surface of a workpiece. The nailing mechanism is adapted to be manipulated from a deactivated state to an activated state when the contact surface of the guide is in contact with the working surface and an angle θ formed between the tool axis and a normal to the working surface is no greater than a predetermined angle.

### BACKGROUND

Attachment devices such as nail guns and staplers can efficiently secure fasteners to a workpiece. For example, a pneumatic nail gun can be utilized to secure two or more workpieces together with a nail. A typical pneumatic nail gun can include a main housing, a magazine connected to the housing that houses one or more nails, and a nailing mechanism disposed within the housing. The nail gun can also include a contact arm that has a free end extending from the housing and that is adapted to be in pressure contact with a working surface of a workpiece, and another end connected to one or both of a trigger disposed on the housing and the nailing mechanism. The contact arm can be movable relative to the housing such that, when the contact arm is pushed or retracted into the housing against a biasing force provided, e.g., by a spring attached to the contact arm, and the trigger is manipulated to an on position, the nailing mechanism can drive the nail from the housing and into the working surface of the workpiece. Once the trigger is manipulated to the on position and the contact arm is engaged with the working surface, the nailing mechanism can drive the nail into the working surface at any angle relative to the working surface.

### SUMMARY

In general, the present disclosure provides various embodiments of a nail gun assembly and a method of forming the nail gun assembly. The nail gun assembly can include a nail gun that includes a housing and a nailing mechanism disposed at least partially within the housing. The nailing mechanism can be adapted to drive a nail along a tool axis and into a working surface of a workpiece when in an activated state but not when in a deactivated state. The assembly can also include a guide connected to the housing. In one or more embodiments, the nailing mechanism is adapted to be manipulated from the deactivated state to the activated state when a contact surface of the guide is in contact with the working surface, and an angle θ formed between the tool axis and a normal to the working surface is no greater than 10 degrees.

In one aspect, the present disclosure provides a nail gun assembly that includes a nail gun including a housing and a nailing mechanism disposed at least partially within the housing, where the nailing mechanism includes an activated state and a deactivated state. The nailing mechanism is adapted to drive a nail along a tool axis of the nail gun and into a working surface of a workpiece when in the activated state but not when in the deactivated state. The nail gun assembly also includes a guide connected to the housing of the nail gun and includes a contact surface that forms a guide plane that is orthogonal to the tool axis, where the contact surface is adapted to contact the working surface of the workpiece. The nailing mechanism is adapted to be manipulated from the deactivated state to the activated state when the contact surface of the guide is in contact with the working surface of the workpiece and an angle θ formed between the tool axis and a normal to the working surface is no greater than 10 degrees.

In another aspect, the present disclosure provides a nail gun assembly that includes a nail gun. The nail gun includes a housing and a nailing mechanism disposed at least partially within the housing, where the nailing mechanism includes an activated state and a deactivated state, and further where the nailing mechanism is adapted to drive a nail along a tool axis and into a working surface of a workpiece when in the activated state but not when in the deactivated state. The nail gun further includes a trigger connected to the nailing mechanism, wherein the trigger includes an on position and an off position, and an actuator extending from the housing along the tool axis. The actuator includes a first end disposed within the housing and connected to the nailing mechanism and a second end including an end surface that is adapted to contact the working surface, where the actuator is adapted to move along the tool axis between a locked position and an unlocked position. The nail gun assembly also includes a guide connected to the housing that includes a contact surface that forms a guide plane that is orthogonal to the tool axis, where the contact surface is adapted to contact the working surface of the workpiece. The nailing mechanism is adapted to be manipulated from the deactivated state to the activated state when the contact surface of the guide and the end surface of the actuator are in contact with the working surface, an angle θ formed between the tool axis and a normal to the working surface is no greater than 10 degrees, the actuator is in the unlocked position, and the trigger is in the on position.

In another aspect, the present disclosure provides a method that includes providing a nail gun assembly including a nail gun and a guide connected to a housing of the nail gun, where the nail gun includes a nailing mechanism disposed at least partially within the housing and that includes an activated state and a deactivated state. The nailing mechanism is adapted to drive a nail along a tool axis of the nail gun and into a working surface of a workpiece when in the activated state but not when in the deactivated state. The method further includes positioning the nail gun assembly on a working surface of a workpiece such that a contact surface of the guide is in contact with the working surface, and manipulating an actuator of the nail gun from a locked position to an unlocked position when a tool axis of the nail gun forms an angle θ with a normal to the working surface of no greater than 10 degrees. The method further includes manipulating a trigger of the nail gun from an off position to an on position, manipulating the nailing mechanism from the deactivated state to the activated state; where the trigger is connected to the nailing mechanism of the nail gun; and driving the nail along the tool axis of the nail gun and into the working surface of the workpiece.

All headings provided herein are for the convenience of the reader and should not be used to limit the meaning of any text that follows the heading, unless so specified.

The terms “comprises” and variations thereof do not have a limiting meaning where these terms appear in the description and claims. Such terms will be understood to imply the inclusion of a stated step or element or group of steps or elements but not the exclusion of any other step or element or group of steps or elements.

In this application, terms such as “a,” “an,” and “the” are not intended to refer to only a singular entity, but include the general class of which a specific example may be used for illustration. The terms “a,” “an,” and “the” are used interchangeably with the term “at least one.” The phrases “at least one of” and “comprises at least one of” followed by a list refers to any one of the items in the list and any combination of two or more items in the list.

The phrases “at least one of” and “comprises at least one of” followed by a list refers to any one of the items in the list and any combination of two or more items in the list.

As used herein, the term “or” is generally employed in its usual sense including “and/or” unless the content clearly dictates otherwise.

The term “and/or” means one or all of the listed elements or a combination of any two or more of the listed elements.

As used herein in connection with a measured quantity, the term “about” refers to that variation in the measured quantity as would be expected by the skilled artisan making the measurement and exercising a level of care commensurate with the objective of the measurement and the precision of the measuring equipment used. Herein, “up to” a number (e.g., up to 50) includes the number (e.g., 50).

Also herein, the recitations of numerical ranges by endpoints include all numbers subsumed within that range as well as the endpoints (e.g., 1 to 5 includes 1, 1.5, 2, 2.75, 3, 3.80, 4, 5, etc.).

These and other aspects of the present disclosure will be apparent from the detailed description below. In no event, however, should the above summaries be construed as limitations on the claimed subject matter, which subject matter is defined solely by the attached claims, as may be amended during prosecution.

### BRIEF DESCRIPTION OF THE DRAWINGS

Throughout the specification, reference is made to the appended drawings, where like reference numerals designate like elements, and wherein:

FIG. 1 is a schematic cross-section view of one embodiment of a nail gun assembly positioned adjacent a working surface of a workpiece.

FIG. 2 is a schematic side plan view of a portion of the nail gun assembly of FIG. 1.

FIG. 3 is a schematic bottom perspective view of a portion of the nail gun assembly of FIG. 1.

FIG. 4 is a schematic top perspective view of the nail gun assembly of FIG. 1, with the assembly disposed such that a tool axis of the nail gun assembly is substantially aligned with a normal to the working surface.

FIG. 5 is a schematic side perspective view of a portion of the nail gun assembly of FIG. 1 with the assembly disposed such that an angle θ is formed between the tool axis and the normal to the working surface.

FIG. 6 is a schematic cross-section view of a portion of the nail gun assembly of FIG. 1.

FIG. 7 is a schematic perspective view of the guide of the nail gun assembly of FIG. 1.

FIG. 8 is a schematic plan view of a contact surface of the guide of the nail gun assembly of FIG. 1.

FIG. 9 is a schematic plan view of a contact surface of another embodiment of a guide.

FIG. 10 is a schematic plan view of a contact surface of another embodiment of a guide.

FIG. 11 is a schematic plan view of a contact surface of another embodiment of a guide.

### DETAILED DESCRIPTION

In general, the present disclosure provides various embodiments of a nail gun assembly and a method of forming the nail gun assembly. The nail gun assembly can include a nail gun that includes a housing and a nailing mechanism disposed at least partially within the housing. The nailing mechanism can be adapted to drive a nail along a tool axis and into a working surface of a workpiece when in an activated state but not when in a deactivated state. The assembly can also include a guide connected to the housing. In one or more embodiments, the nailing mechanism is adapted to be manipulated from the deactivated state to the activated state when a contact surface of the guide is in contact with the working surface, and an angle θ formed between the tool axis and a normal to the working surface is no greater than 10 degrees.

In general, a nail gun can include a housing, a magazine connected to the housing, and a nailing mechanism disposed at least partially within the housing. The nail gun can also include a contact arm having a free end that extends from the housing and that is adapted to be in pressure contact with a working surface of a workpiece. The contact arm is typically biased in a direction away from the housing along a tool axis of the nail gun. Further, the contact arm is movable relative to the housing along the tool axis. When the contact arm is pushed into the housing against a biasing force of a spring connected to the contact arm, and a trigger of the nail gun is disposed in an on position, the driving mechanism can drive a nail into the working surface of the workpiece.

Further, a typical nail gun is operable to drive the nail into the working surface of the workpiece at any angle formed between the tool axis and a normal to the working surface. Some applications, however, require that the nail be driven into the working surface at or near a 90 degree angle to the working surface. For example, when assembling and repairing pallets, a runner board on a top or bottom surface of the pallet is desirably attached or fastened to a support block or end board. A nail gun can be used to attach the runner to the support block. If, however, the nail gun drives the nail through the runner at an angle other than, e.g., within 10 degrees of normal to the working surface of the runner, the nail may break through a side of the support block. This protruding nail could potentially catch on other pallets or materials. Further, the protruding nail may not effectively attach the runner to the support block, thereby weakening the pallet and making it more likely that the pallet will break.

One or more embodiments of nail gun assemblies described herein can include a guide connected to a housing of a nail gun of the assembly, where the guide is adapted to prevent the nail gun from driving a nail into a working surface of a workpiece unless a tool axis of the nail gun is substantially aligned with a normal to the working surface of the workpiece. In one or more embodiments, a driving mechanism of the nail gun that is adapted to drive a nail into the working surface may not be capable of being manipulated from a deactivated state to an activated state unless the tool axis of the nail gun is within a predetermined angle of the normal to the working surface. For example, in one or more embodiments, the nail gun may be capable of driving a nail into the working surface only when the tool axis of the nail gun forms an angle with the normal to the working surface that is, e.g., no greater than 10 degrees.

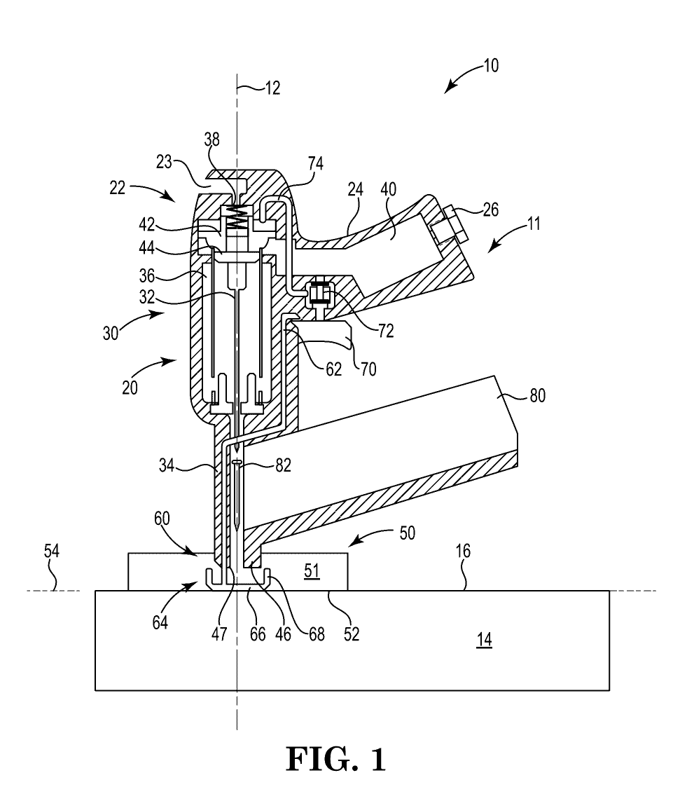

The various embodiments of guides described herein can be utilized with any suitable nail gun or attachment device, e.g., nail guns, staplers, etc. For example, FIGS. 1-8 are various views of one embodiment of a nail gun assembly 10. The nail gun assembly 10 includes a nail gun 11 and a guide 50 connected to a housing 20 of the nail gun. The nail gun 11 can be any suitable type of nail gun or attachment device e.g., spring-loaded, electric, pneumatic, combustion, etc. The nail gun 11 includes the housing 20 and a nailing mechanism 30 disposed at least partially within the housing. As used herein, the term “at least partially within the housing” means that at least a portion of the nailing mechanism 30 is disposed within the housing 20.

The housing 20 can take any suitable shape or combination of shapes and include any suitable dimensions. Further, the housing 20 can include any suitable material or combination materials, e.g., metal, polymeric, etc. In one or more embodiments, the housing 20 includes a steel material. The housing 20 also includes a main body 22 and a handle 24 that extends from the main body. The handle 24 can take any suitable shape or combination of shapes. In one or more embodiments, the handle 24 can take an ergonomic shape that is adapted to be gripped by a hand of a user. The housing 20 can also include an air inlet 26 disposed in any suitable location on or in the housing. The air inlet 26 is adapted to connect the nail gun 11 to a pressurized gas supply to provide pressurized gas, e.g., air, to the nail gun.

The nailing mechanism 30, which is disposed at least partially within the housing 20, can include an activated state and a deactivated state. The nailing mechanism 30 can be adapted to drive a nail 82 or other fastener along a tool axis 12 of the nail gun 11 and into a working surface 16 of a workpiece 14 when the nailing mechanism is in the activated state. The nailing mechanism 30, however, is adapted such that it is not capable of driving the nail 82 along the tool axis 12 of the nail gun 11 and into the working surface 16 of the workpiece 14 when in the deactivated state.

The nailing mechanism 30 can include any suitable nailing mechanism that is adapted to drive a nail along the tool axis 12 of the nail gun 11 and into the working surface 16 of the workpiece 14. As illustrated, the nailing mechanism 30 includes a driver 32 and a nose 34 that extends from the housing 20 to an end surface 46 of the nose. An opening 47 can be disposed in the end surface 46 of the nose 34 through which the nail 82 can be driven by the nailing mechanism 30 and into the working surface 16. Connected to the driver 32 is a piston head 44 that sits adjacent a valve plunger 42. The driver 32, nose 34, and piston head 44 can be aligned along the tool axis 12. The driver 32 and piston head 44 can be disposed within a return air chamber 36. The nailing mechanism 30 can also include a spring 38 connected to the valve plunger 42. In one or more embodiments, the spring 38 can provide a mechanical force to aid in returning the valve plunger 42 to a closed position (as shown in FIG. 1).

In one or more embodiments, the nail gun 11 can also include a trigger 70 that can be disposed on or in the handle 24 of the housing 20. The trigger 70 can be connected to a trigger valve 72. The trigger 70 can include an on position and an off position. When the trigger 70 is in the off position, the nailing mechanism 30 cannot be in the activated state. For example, if the nailing mechanism 30 is in the deactivated state and the trigger 70 is in the off position, then the nailing mechanism cannot be manipulated to the activated state. Further, when the trigger 70 is in the on position, the nailing mechanism 30 can be in the activated state if an actuator 60 of the nail gun assembly 10 is in an unlocked position as is further described herein. When the trigger 70 is manipulated from the off position to the on position and the actuator 60 is in the unlocked position, air is removed from the top of the valve plunger 42. Compressed air disposed in a reservoir 40 can overcome the mechanical force of the spring 38 by moving through the trigger valve 72 and a conduit 74 to above the piston 44, forcing the piston along the tool axis 12 and toward the working surface 16, thereby providing energy (i.e., a driving force) to the nail 82 such that it is driven out of the nose 34.

In general, when air pressure above the piston head 44 is greater than below it, i.e., within the return air chamber 36, the piston head is forced downward toward the working surface 16 of the workpiece 14. When the air pressure below the piston head 44 is greater than above it, the piston head remains in place, i.e., the nailing mechanism 30 is in the deactivated state. The trigger 70 and trigger valve 72 can serve to channel flow of compressed air from a compressed air source coupled to the nail gun 11 at air inlet 26 to shift the balance between the air pressure within the return air chamber 36 and the air pressure above the piston head 42. When the trigger 70 is manipulated from the on position to the off position, compressed air pushes the plunger 42 back into place, blocking the airflow to the piston head 44. With no downward pressure toward the working surface 16, the compressed air in the return air chamber 36 can drive the piston head 44 back to its original position such that the nailing mechanism 30 is in the deactivated state. The air above the piston head 44 can be forced out of the gun 11 and into the atmosphere through air outlet 23.

As mentioned herein, the nail gun 11 can also include an actuator 60 connected to one or both of the nailing mechanism 30 and the trigger 70. The actuator 60 can take any suitable shape or combination of shapes and be disposed in any suitable location relative to the housing 20. In one or more embodiments, the actuator 60 can include a sleeve portion 68 that at least partially surrounds the nose 34. As used herein, the term “at least partially surrounds” means that the sleeve portion 68 of the actuator 60 is adjacent at least two or more sides of the nose 34. In one or more embodiments, the actuator 60 can be a rod or lever that extends from the housing 20 but does not at least partially surround the nose 34.

In one or more embodiments, the actuator 60, nailing mechanism 30, and guide 50 can be aligned along the tool axis 12 as shown in FIG. 1. The actuator 60 can extend from the housing 20 along the tool axis 12. The actuator 60 can include a first end 62 connected to at least one of the nailing mechanism 30 and the trigger 70, and a second end 64 that extends beyond the housing 20 of the nail gun 11 along the tool axis 12. The actuator 60 can also include an end surface 66 at or near the second end 64 that is adapted to contact the working surface 16 of the workpiece 14.

In one or more embodiments, the actuator 60 is adapted to move along the tool axis 12 between a locked position and an unlocked position. In one or more embodiments, the actuator 60 can be biased in the locked position. Further, in one or more embodiments, the contact surface 66 of actuator 60 can be at a first distance from the housing 20 along the tool axis 12 when the actuator is in the locked position, and the contact surface of the actuator can be at a second distance from the housing along the tool axis when in the unlocked position. In one or more embodiments, the first distance is greater than the second distance.

Any suitable technique or combination of techniques can be utilized such that the actuator 60 can prevent the nailing mechanism 30 from being manipulated from the deactivated state to the activated state. In the embodiment illustrated in FIG. 1, the first end 62 of the actuator 60 is connected to the trigger 70 such that the actuator prevents the trigger 70 from being manipulated from the off position to the on position until the actuator is manipulated from the locked position to the unlocked position, e.g., by mechanically engaging the trigger 70. In one or more embodiments, the actuator 60 can be mechanically connected to the nailing mechanism 30 such that the nailing mechanism is prevented from being manipulated from the deactivated state to the activated state when the actuator is in the locked position. Although the actuator 60 in FIG. 1 is mechanically connected to the trigger 70, in one or more embodiments, the actuator can be electrically connected to one or both of the trigger 70 and the nailing mechanism 30 such that, when in the locked position, the actuator prevents the trigger from being manipulated from the off position to the on position, or the actuator prevents the nailing mechanism from being manipulated from the deactivated state to the activated state. Any suitable device or combination of devices can be utilized to electrically connect the actuator 60 to one or both of the trigger 70 and the nailing mechanism 30, e.g., switches, sensors, controllers, etc.

Connected to the housing 20 of the nail gun 11 is the guide 50. The guide 50 includes a contact surface 52 that forms a guide plane 54. The contact surface 52 of the guide 50 is adapted to contact the working surface 16 of the workpiece 14. The guide plane 54 can form any suitable angle with the tool axis 12. In one or more embodiments, the guide plane 54 forms an angle with the tool axis 12 such that the guide plane is substantially orthogonal to the tool axis. As used herein, the term “substantially orthogonal” means that the guide plane 54 forms an angle with the tool axis 12 that is at least 85 degrees and no greater than 95 degrees.

The contact surface 52 can be disposed on a body 51 of the guide 50. The body 51 can include any suitable material or combination of materials, e.g., metal, polymeric, wood, etc. For example, in one or more embodiments, the body 51 can be formed from steel to provide a durable contact surface 52. The body 51 can take any suitable shape or combination of shapes. The contact surface 52 can include the same material or materials as the body 51. In one or more embodiments, the contact surface 52 can include a material or materials that are different from the material or materials of the body 51. The contact surface 52 can be integral with the body 51. In one or more embodiments, the contact surface 52 can be made separately from the body 51 and attached to the body using any suitable technique or combination of techniques.

The contact surface 52 can take any suitable shape in a plane orthogonal to the guide plane 54. For example, in one or more embodiments, the contact surface 52 can be a flat surface. In one or more embodiments, the contact surface 52 can be a rounded surface. Further, in one or more embodiments, the contact surface 52 can be a faceted surface. The contact surface 52 can include any suitable area in the guide plane 54.

In general, the contact surface 52 provides at least three or more contact points that are adapted to contact the working surface 16 of the workpiece 14 such that the guide 50 positions the nail gun 11 in an orientation where the tool axis 12 is substantially orthogonal to the working surface 16 of the workpiece 14. As used herein, the term “substantially orthogonal” means that the tool axis 12 forms an angle with a normal 18 (FIG. 5) of the working surface 16 of the workpiece 14 that is no greater than 10 degrees. Any suitable number of contact points can be provided by the contact surface 52 of the guide 50.

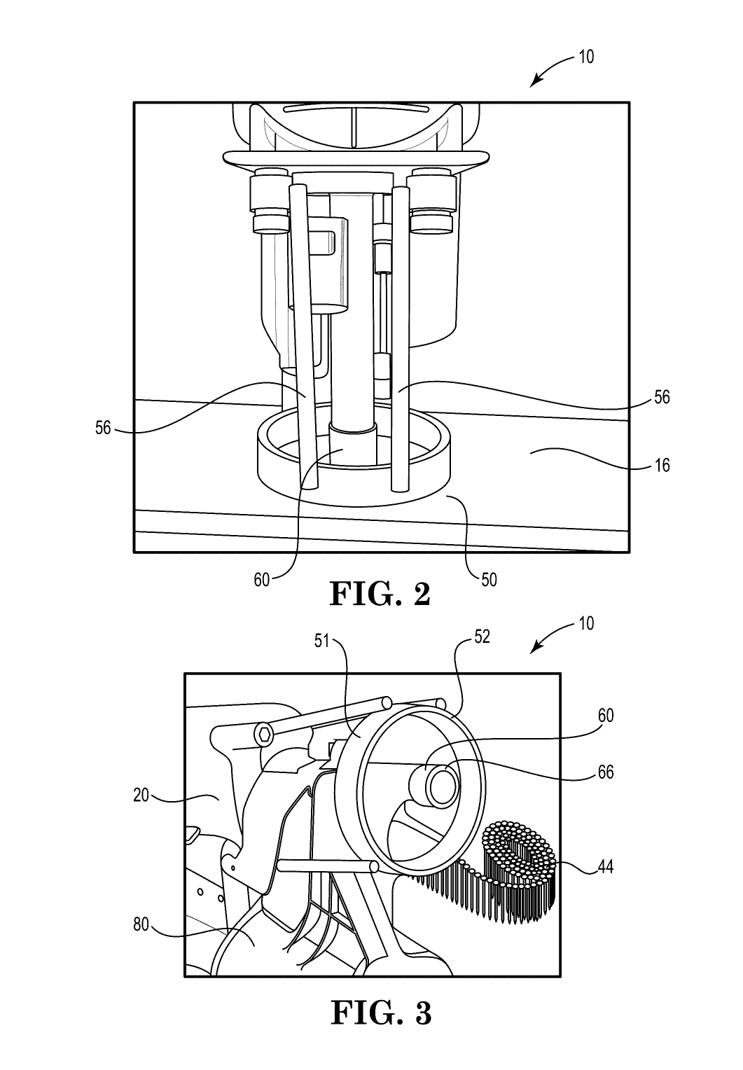

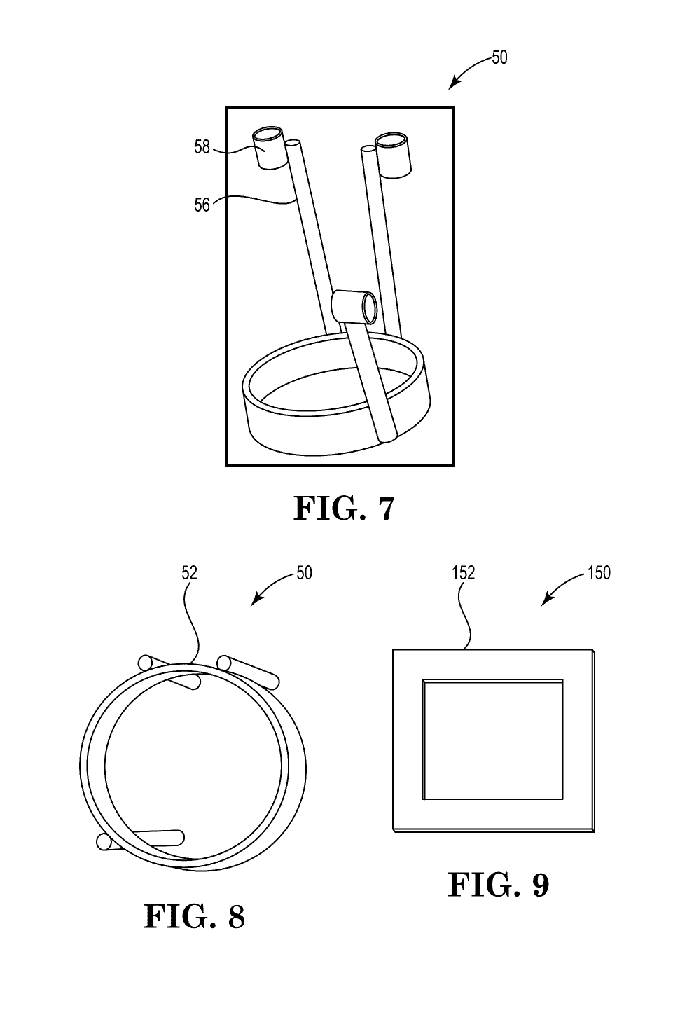

The guide 50 can be connected to the housing 20 of the nail gun 11 using any suitable technique or combination of techniques. In one or more embodiments, the guide 50 is connected to the housing 20 using one or more braces 56 as shown in FIGS. 2-7. The braces 56 are not shown in FIG. 1 for clarity. The braces 56 can extend from the body 51 of the guide 52, and one or more connectors 58 (FIG. 7) can be attached to the ends of the braces (FIG. 7) to connect the guide to the housing 20. Any suitable connectors 58 can be utilized to connect the guide 50 to the housing 20. The braces 56 can be integral with the body 51 of the guide 50. In one or more embodiments, one or more of the braces 56 can be attached to the body 51 of the guide 50 using any suitable technique or combination of techniques. The guide 50 can be attached to any suitable portion or portions of the housing 20 of the nail gun 11. Further, the braces 56 can be attached to the housing 20 and extend any suitable distance to the body 51 such that the body is disposed adjacent the end surface 46 of the nose 34.

As mentioned herein, the body 51 of the guide 50 can take any suitable shape or combination of shapes and have any suitable dimensions. In one or more embodiments, the body 51 of the guide 50 at least partially surrounds the end surface 46 of the nose 34. As used herein, the term “at least partially surrounds” means that the guide 50 is positioned such that the body 51 surrounds at least two sides of the nose 34 of the nailing mechanism 30. For example, as shown in FIG. 3, the body 51 of the guide 50 completely surrounds the nose 34.

In one or more embodiments, the body 51 of the guide 50 can take a shape such that the contact surface 52 has any suitable shape in the guide plane 54, e.g., elliptical, rectilinear, etc. For example, the contact surface 52 of the guide 50 in the embodiment illustrated in FIGS. 1-8 includes a circular shape in the guide plane 54. In one or more embodiments, the contact surface of the guide can have a rectangular shape in the guide plane. For example, FIG. 9 is a schematic plan view of another embodiment of a guide 150. All of the design considerations and possibilities regarding the guide 50 of the nail gun assembly 10 of FIGS. 1-8 apply equally to the guide 150 of FIG. 9. The guide 150 has a contact surface 152 that is rectangular (e.g. square) in a guide plane (not shown).

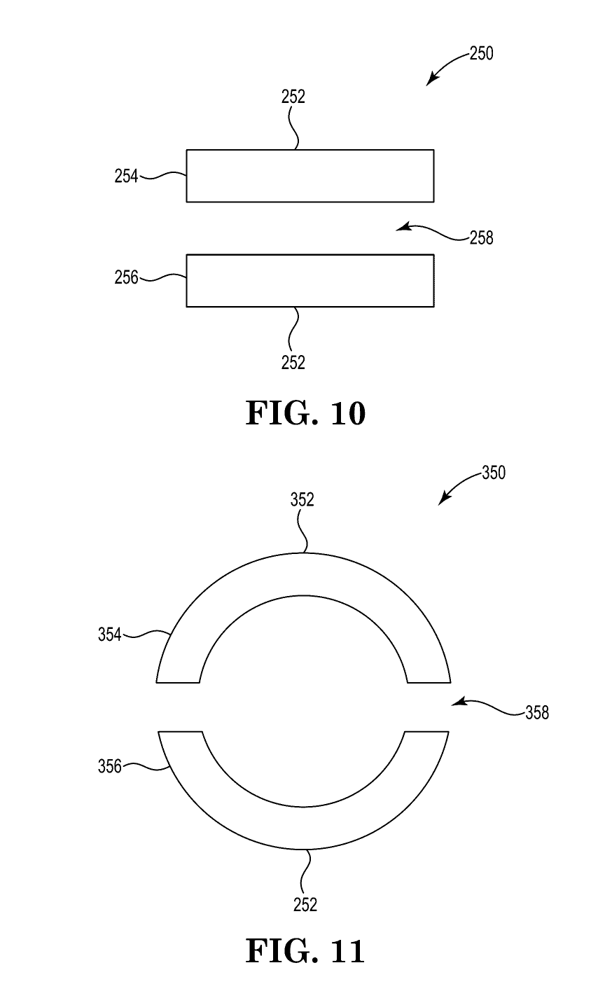

The contact surface 52 of the guide 50 can be a continuous surface as shown in FIGS. 1-8. In one or more embodiments, the contact surface 52 can be a discontinuous surface such that portions of the contact surface are separated by one or more gaps. For example, FIG. 10 is a schematic plan view of another embodiment of a guide 250. All of the design considerations and possibilities regarding the guide 50 of FIGS. 1-8 apply equally to the guide 250 of FIG. 10. One difference between the guide 250 of FIG. 10 and the guide 50 of FIGS. 1-8 is that a contact surface 252 of the guide 250 includes a first segment 254 and a second segment 256. The first and second segments 254, 256 are separated by a gap 258. Although the contact surface 252 includes two segments 254, 256, in one or more embodiments, the contact surface can include any suitable number of segments. Further, the first and second segments 254, 256 can be part of a unitary body (not shown), i.e., extend from a unitary body, or the first and second segments can be part of two or more separate bodies that are each attached to a housing of a nail gun (i.e., housing 20 of nail gun 11).

The first and second segments 254, 256 each includes a linear shape in the guide plane (i.e., the plane of the figure). In one or more embodiments, the first and second segments 254, 256 can take any suitable shape or combination of shapes in the guide plane. For example, FIG. 11 is a schematic plan view of another embodiment of a guide 350. All of the design considerations and possibilities regarding the guide 50 of FIGS. 1-8 and the guide 250 of FIG. 10 apply equally to the guide 350 of FIG. 11. As shown in FIG. 11, the guide 350 includes a contact surface 352 that has a first segment 354 and a second segment 356. The first and second segments 354, 356 are separated by a gap 358. Each of the first and second segments 354, 356 has a curved shape in a guide plane (i.e., the plane of the figure). In one or more embodiments one of the first and second segments 354, 356 can have a linear shape in the guide plane and the other segment can have a curved shape.

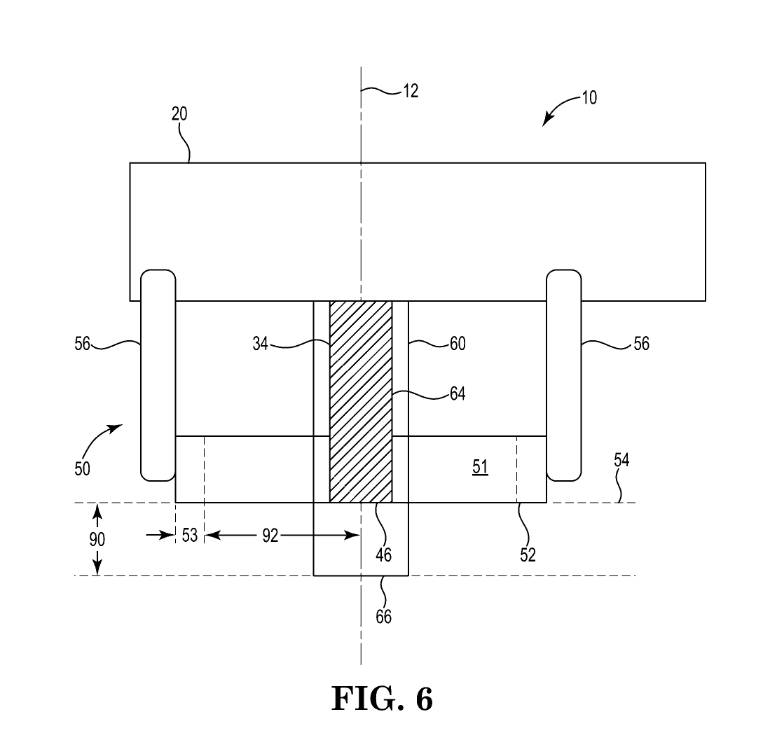

Returning to FIGS. 1-8, the guide 50 can extend any suitable distance from the housing 20 of the nail gun 11 in relation to the distance that the actuator 60 and the end surface 46 of the nose 34 extend from the housing. For example, FIG. 6 is a schematic cross-section view of a portion of the nail gun assembly 10. As shown in FIG. 6, the guide 50 is adapted such that the end surface 66 of the actuator 60 is disposed at an offset distance 90 from the guide plane 54 along the tool axis 12. The offset distance 90 can be any suitable length. In one or more embodiments, the offset distance 90 is at least 5 mm. In one or more embodiments, the offset distance 90 is no greater than 25 mm.

As stated herein, the end surface 46 of the nose 34 can be disposed at any suitable offset distance along the tool axis 12 from the guide plane 54 either above the guide plane (i.e., between the guide plane and the housing 20) or below the guide plane (i.e., the guide plane is between the end surface and the housing). In one or more embodiments, the end surface 46 of the nose 34 can be disposed at an offset distance along the tool axis 12 from the guide plane 54 of no greater than 10 mm. In one or more embodiments, the end surface 46 of the nose 34 is disposed such that it is in the guide plane 54, i.e., the offset distance between the end surface of the nose and the guide plane 54 is about 0 mm. In other words, the end surface 46 of the nose 34 is flush with the contact surface 52 of the guide 50 such that the end surface is in the guide plane 54.

Further, the contact surface 52 can be adapted such that it is spaced apart from the tool axis 12. For example, the contact surface 52 can be spaced a distance 92 from the tool axis 12. The distance 92 can be any suitable distance, e.g., at least 12 mm, no greater than 40 mm, etc. In one or more embodiments, the contact surface 52 can be symmetrical about the tool axis 12 such that the distance 92 is substantially the same for the entire contact surface. Further, the contact surface 52 can have a constant width 53. In one or more embodiments, the width 53 of the contact surface 52 can vary.

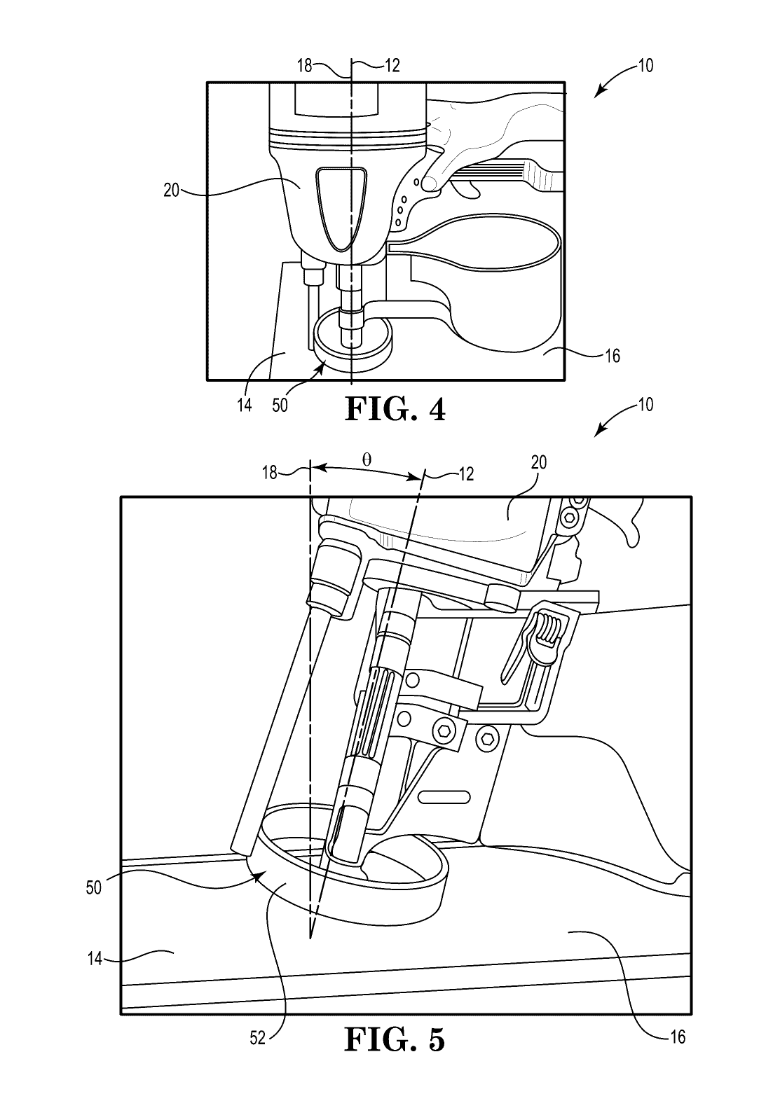

In general, the various embodiments of guides described herein are adapted to prevent a nail gun from driving a nail into a workpiece at an angle to a normal to a working surface of the workpiece that is greater than a predetermined angle. The predetermined angle can be any suitable angle, e.g., 15 degrees, 10 degrees, 5 degrees, 1 degree, etc. For example, FIGS. 4-5 are schematic side views of the nail gun assembly 10. As shown in FIG. 4, the nail gun assembly 10 is disposed in relation to the working surface 16 of the workpiece 14 such that the contact surface 52 of the guide 50 is in contact with the working surface. Further, the nail gun assembly 10 is disposed such that the tool axis 12 is substantially collinear with the normal 18 to the working surface 16, i.e., the angle formed between the tool axis 12 and the normal 18 is about 0 degrees. When disposed in this position, the guide 50 is adapted such that the end surface 66 of the actuator 60 (FIG. 1) is in contact with the working surface 16 and has been manipulated from the locked position to the unlocked position. When disposed in this position, the nail gun assembly 10 is capable of driving the nail 82 (FIG. 1) into the working surface 16 when the trigger 70 (FIG. 1) is in the on position. In other words, a user can drive the nail 82 into the working surface 16 of workpiece 14 by positioning the nail gun assembly 10 such that the contact surface 52 of the guide 50 is in contact with the working surface, the trigger 70 is in the on position, and the angle θ formed between the tool axis 12 and the normal 18 is about 0 degrees. When positioned in this orientation, the nail 82 is driven by the nailing mechanism 30 in a substantially orthogonal direction into the working surface 16 of the workpiece 14.

If, however, under normal operating conditions, the user positions the nail gun assembly 10 in relation to the working surface 16 such that contact surface 52 is not in contact with the working surface 16, then the actuator 60 has not been manipulated from the locked position to the unlocked position. When the actuator 60 is in the locked position, the nailing mechanism 30 of the nail gun 11 cannot be manipulated from the deactivated state to the activated state. When in the deactivated state, the nailing mechanism 30 cannot drive a nail.

Further, in one or more embodiments, the nailing mechanism 30 can remain in the deactivated state and incapable of driving the nail 82 into the working surface 16 when the angle θ between the tool axis 12 and the normal 18 to the working surface 16 is greater than a predetermined angle. For example, as shown in FIG. 5, the nail gun assembly 10 is disposed in relation to the working surface 16 of the workpiece 14 such that an angle θ greater than the predetermined angle is formed between the tool axis 12 and the normal 18 to the working surface, and the contact surface 52 is at least in partial contact with the working surface. When in this position, the actuator 60 cannot be manipulated from the locked position to the unlocked position even though the end surface 66 of the actuator is in contact with the working surface 16. In other words, the configuration of the guide 50 and its position relative to the actuator 60 can, in one or more embodiments, prevent the actuator from being manipulated from the locked position to the unlocked position until the nail gun 11 is positioned with the tool axis 12 forming angle θ with the normal 18 that is no greater than a predetermined angle.

For example, the guide 50 can be configured and disposed in relation to the actuator 60 such that the actuator can be manipulated from the locked position to the unlocked position when the contact surface 52 of the guide is in contact with the working surface 16, and the tool axis 12 forms angle θ with the normal 18 that is no greater than, e.g., 10 degrees. In such embodiments, the actuator 60 is capable of being manipulated from the locked position to the unlocked position when the tool axis 12 is at no greater than a 10 degree angle relative to the normal 18 and the contact surface 52 of the guide is in contact with the working surface 16.

In one or more embodiments, the actuator 60 cannot be manipulated from the locked position to the unlocked position until the end surface 66 of the actuator is in the guide plane 54. Any suitable relationship between the dimensions of the end surface 66 of the actuator 60, the dimensions of the contact surface 52 in the guide plane 54, and the offset distance 90 between the end surface of the actuator and the contact surface 52 along the tool axis 12 can be provided such that the nailing mechanism can only be manipulated from the deactivated state to the activated state when the predetermined angle is formed between the tool axis 12 and the normal 18 to the working surface 16. In general, the larger the diameter of the contact surface 52 of the guide 50, the greater the offset distance 90 needs to be to provide the desired predetermined angle.

The various embodiments of nail gun assemblies described herein can be utilized to drive a nail or other type of fastener into a working surface of a workpiece using any suitable technique or combination of techniques. For example, in reference to the nail gun assembly 10 illustrated in FIGS. 1-8, a user can position the nail gun assembly on the working surface 16 of the workpiece 14 such that the contact surface 52 of the guide 50 is in contact with the working surface. The user can manipulate the nail gun 11 of the assembly 10 by changing the angle between the tool axis 12 and the normal 18 to the working surface 16 until such angle is no greater than a predetermined angle θ, e.g., no greater than 10 degrees. When the nail gun 11 is positioned such that the angle θ between the tool axis 12 and the normal 18 is no greater than the predetermined angle, the actuator 60 can be manipulated from the locked position to the unlocked position.

When the trigger 70 is manipulated from the off position to the on position and the actuator 60 is in the unlocked position, the nailing mechanism 30 can be manipulated from the deactivated state to the activated state. When in the activated state, the nailing mechanism 30 can drive the nail 82 into the working surface 16 of the workpiece 14. In one or more embodiments, the nail gun assembly 10 can be configured such that the user can manipulate the trigger 70 from the on position to the off position either before or after the actuator 60 has been manipulated from the locked position to the unlocked position. For example, the user can manipulate the trigger 70 from the off position to the on position prior to disposing the nail gun assembly 10 such that it is in contact with the working surface 16 of the workpiece 14. Even though the user manipulates the trigger 70 from the off position to the on position, the nailing mechanism 30 cannot be manipulated to the activated state unless the actuator 60 has been manipulated to the unlocked position. In other words, the nailing mechanism 30 cannot be in the activated state unless the trigger 70 is in the on position and the actuator 60 is in the unlocked position. In one or more embodiments, the nailing mechanism 30 can be manipulated to the activated state by manipulating the actuator 60 to the unlocked position followed by manipulating the trigger 70 to the on position, manipulating the actuator to the unlocked position simultaneously with manipulating the trigger to the on position, or manipulating the trigger to the on position and then manipulating the actuator to the unlocked position.

Further, in one or more embodiments, the nail gun assembly 10 can be adapted such that the nailing mechanism 30 is manipulated from the activated state to the deactivated state when the angle θ formed between the tool axis 12 and the normal 18 to the working surface 16 is greater than the predetermined angle, e.g., greater than 10 degrees, even though the trigger 70 remains in the on position. In other words, the nailing mechanism 30 can be manipulated from the activated state to the deactivated state by positioning the nail gun 11 such that angle θ is greater than the predetermined angle even though the trigger 70 remains in the on position.

All references and publications cited herein are expressly incorporated herein by reference in their entirety into this disclosure, except to the extent they may directly contradict this disclosure. Illustrative embodiments of this disclosure are discussed and reference has been made to possible variations within the scope of this disclosure. These and other variations and modifications in the disclosure will be apparent to those skilled in the art without departing from the scope of the disclosure, and it should be understood that this disclosure is not limited to the illustrative embodiments set forth herein. Accordingly, the disclosure is to be limited only by the claims provided below.

What is claimed is:

1. A nail gun assembly, comprising:
a nail gun comprising a housing and a nailing mechanism disposed at least partially within the housing, wherein the nailing mechanism comprises an activated state and a deactivated state, and further wherein the nailing mechanism is adapted to drive a nail along a tool axis of the nail gun and into a working surface of a workpiece when in the activated state but not when in the deactivated state; and
a guide connected to the housing of the nail gun and comprising a contact surface that forms a guide plane that is orthogonal to the tool axis, wherein the contact surface is adapted to contact the working surface of the workpiece;
wherein the nailing mechanism is adapted to be manipulated from the deactivated state to the activated state when the contact surface of the guide is in contact with the working surface of the workpiece and an angle θ formed between the tool axis and a normal to the working surface is no greater than 10 degrees.

2. The assembly of claim 1, wherein the nail gun further comprises:
an actuator extending from the housing along the tool axis, wherein the actuator comprises an end surface adapted to contact the working surface, wherein the actuator is adapted to move along the tool axis between a locked position and an unlocked position; and
a trigger connected to the nailing mechanism and comprising an on position and an off position;
wherein the nailing mechanism is adapted to be manipulated from the deactivated state to the activated state when the trigger is manipulated from the off position to the on position and the actuator is manipulated from the locked position to the unlocked position.

3. The assembly of claim 2, wherein the guide at least partially surrounds the actuator.

4. The assembly of claim 2, wherein the end surface of the actuator is disposed at an offset distance from the guide plane along the tool axis, wherein the offset distance is at least 5 mm and no greater than 25 mm.

5. The assembly of claim 1, wherein the contact surface of the guide comprises an elliptical shape in the guide plane.

6. The assembly of claim 1, wherein the contact surface of the guide comprises a rectangular shape in the guide plane.

7. The assembly of claim 1, wherein θ is no greater than 5 degrees.

8. The assembly of claim 1, wherein the contact surface of the guide comprises first and second segments separated by a gap, wherein each of the first and second segments is connected to the housing.

9. The assembly of claim 8, wherein at least one of the first and second segments comprises a linear shape in the guide plane.

10. The assembly of claim 8, wherein the at least one of the first and second segments comprises a curved shape in the guide plane.

11. The assembly of claim 1, wherein the nailing mechanism further comprises a nose that extends from the housing to an end surface of the nose adapted to contact the working surface, wherein the end surface of the nose is disposed at an offset distance along the tool axis from the guide plane of no greater than 10 mm.

12. A nail gun assembly, comprising:
a nail gun comprising:
a housing and a nailing mechanism disposed at least partially within the housing, wherein the nailing mechanism comprises an activated state and a deactivated state, and further wherein the nailing mechanism is adapted to drive a nail along a tool axis and into a working surface of a workpiece when in the activated state but not when in the deactivated state;
a trigger connected to the nailing mechanism and comprising an on position and an off position; and
an actuator extending from the housing along the tool axis, wherein the actuator comprises a first end disposed within the housing and connected to the nailing mechanism and a second end comprising an end surface that is adapted to contact the working surface, wherein the actuator is adapted to move along the tool axis between a locked position and an unlocked position; and
a guide connected to the housing and comprising a contact surface that forms a guide plane that is orthogonal to the tool axis, wherein the contact surface is adapted to contact the working surface of the workpiece;
wherein the nailing mechanism is adapted to be manipulated from the deactivated state to the activated state when the contact surface of the guide and the end surface of the actuator are in contact with the working surface, an angle θ formed between the tool axis and a normal to the working surface is no greater than 10 degrees, the actuator is in the unlocked position, and the trigger is in the on position.

13. The assembly of claim 12, wherein the actuator is biased to the locked position, wherein the actuator is manipulated from the locked position to the unlocked position by pressing the actuator against the working surface.

14. The assembly of claim 12, wherein the actuator comprises a sleeve portion adjacent the second end, wherein the nailing mechanism comprises a nose that extends from the housing along the tool axis, wherein the nose is disposed within the sleeve portion, and further wherein an end surface of the nose is disposed within the sleeve at an offset distance along the tool axis from the end surface of the actuator when the actuator is in the locked position.

15. The assembly of claim 14, wherein the guide further comprises a body and a brace that connects the body to the housing, wherein the contact surface is disposed on the body.

16. the assembly of claim 15, wherein the body of the guide at least partially surrounds the end surface of the nose and the second end of the actuator.

17. The assembly of claim 12, wherein the nailing mechanism, the actuator, and the guide are aligned along the tool axis.

18. A method, comprising:
providing a nail gun assembly comprising a nail gun and a guide connected to a housing of the nail gun, wherein the nail gun comprises a nailing mechanism disposed at least partially within the housing and comprising an activated state and a deactivated state, and further wherein the nailing mechanism is adapted to drive a nail along a tool axis of the nail gun and into a working surface of a workpiece when in the activated state but not when in the deactivated state;
positioning the nail gun assembly on a working surface of a workpiece such that a contact surface of the guide is in contact with the working surface;
manipulating an actuator of the nail gun from a locked position to an unlocked position when a tool axis of the nail gun forms an angle θ with a normal to the working surface of no greater than 10 degrees;
manipulating a trigger of the nail gun from an off position to an on position, wherein the trigger is connected to the nailing mechanism of the nail gun;
manipulating the nailing mechanism from the deactivated state to the activated state; and
driving the nail along the tool axis of the nail gun and into the working surface of the workpiece.

19. The method of claim 18, wherein manipulating the actuator comprises manipulating the actuator from the locked position to the unlocked position when the angle θ formed between the tool axis and the normal to the working surface is no greater than 5 degrees.

20. The method of claim 18, further comprising manipulating the nailing mechanism from the activated state to the deactivated state when the angle θ formed between the tool axis and the normal to the working surface is greater than 10 degrees.
